(19) United States
(12) Patent Application Publication
(10) Pub. No.: US 2017/0345014 A1
(43) Pub. Date: Nov. 30, 2017

(54) Question and Answer Enhancement

(71) Applicant: International Business Machines Corporation, Armonk, NY (US)

(72) Inventors: Nadiya Kochura, Bolton, MA (US); Fang Lu, Billerica, MA (US); Anupriya Ray, Bolton, MA (US); Tejaswini K. Ranadive, Westford, MA (US); Sneha Palarapu, Nashua, NH (US)

(73) Assignee: International Business Machines Corporation, Armonk, NY (US)

(21) Appl. No.: 15/163,519

(22) Filed: May 24, 2016

(51) Int. Cl. G06Q 30/00; G06F 17/27; G06F 17/28; G06F 17/30

(52) U.S. Cl. CPC G06Q 30/016; G06F 17/30684; G06F 17/2705; G06F 17/28; G06F 17/30675

(57) ABSTRACT

A system for generating a set of questions about an upcoming product characterized by a number of product characteristics. The system identifies similar products having one or more of the same product characteristics. The system searches for and finds product statements associated with each of the similar products, rephrases the product statements to be questions about the upcoming product, then ranks the questions to create the set of questions about the upcoming product.

### BACKGROUND

### Technical Field

Various embodiments of the present invention relate to apparatus and methods that generate information, and more specifically, to apparatus and methods that generate an evaluative framework of questions about a new product or service.

### Description of Related Art

The process of developing and rolling out a new product involves generating information and instructions for the product. Conventional systems have attempted to generate information needed for a new product, for example, a system for generating frequently asked questions (FAQs) for a product. However, these attempts fail to take into account the specific features and characteristics of the product being described as compared to other, similar products that may already be available.

### BRIEF SUMMARY

What is needed is a system for generating an evaluative framework for a new product or service that includes questions pertaining to relevant features and characteristics of the product.

According to various embodiments disclosed herein method and systems are provided for generating a set of questions about an upcoming product. An upcoming product characterized by a plurality of product characteristics is selected, and a plurality of similar products are identified based on each of the similar products having one or more of the plurality of product characteristics. The system search for and finds product statements associated with each of the plurality of similar products. An evaluation is performed to identify sentiment in the product statements. The evaluation to identify the sentiment may use natural language processing (NLP) or machine learning (ML) to parse and analyze the text of the product statements. The product statements are rephrased to be inquiries about the upcoming product, and a set of questions is created from the rephrased product statements.

### BRIEF DESCRIPTION OF THE DRAWINGS

The accompanying drawings, which are incorporated in and constitute part of the specification, illustrate various embodiments of the invention. Together with the general description, the drawings serve to explain the principles of the invention. In the drawings:

FIG. 1 is a flowchart depicting a method according to various embodiments disclosed herein;

FIG. 2 is a flowchart depicting various preliminary and optional activities that may be performed for the various embodiments disclosed herein;

FIG. 3 depicts a block diagram of various elements in accordance with embodiments disclosed herein; and

FIG. 4 depicts computer and hardware systems for use in implementing various embodiments disclosed herein.

### DETAILED DESCRIPTION

Any time a new product is released customers will have a number of questions about the product—both at the time of making the purchasing decision and after the product has been purchased. The potential customer often bases their purchase decision on the answers to questions about the new product's features, reliability and characteristics. The customer who has recently purchased the new product may have many of these same questions, as well as questions about installing new product, or operating various features of the product, or possibly questions about maintenance and trouble-shooting. The methods and systems disclosed herein produce a question set for a new product that includes questions likely to be asked by a customer, both before and after the purchase. The methods and systems identify new product characteristics with ratings of the customer interests that are mapped to previously collect question sets from social media, customer feedback, product marketing information and presentations, or the like. In addition, predicted questions may in some instances be mapped to new products, services and events based on established characteristics mapping with available products.

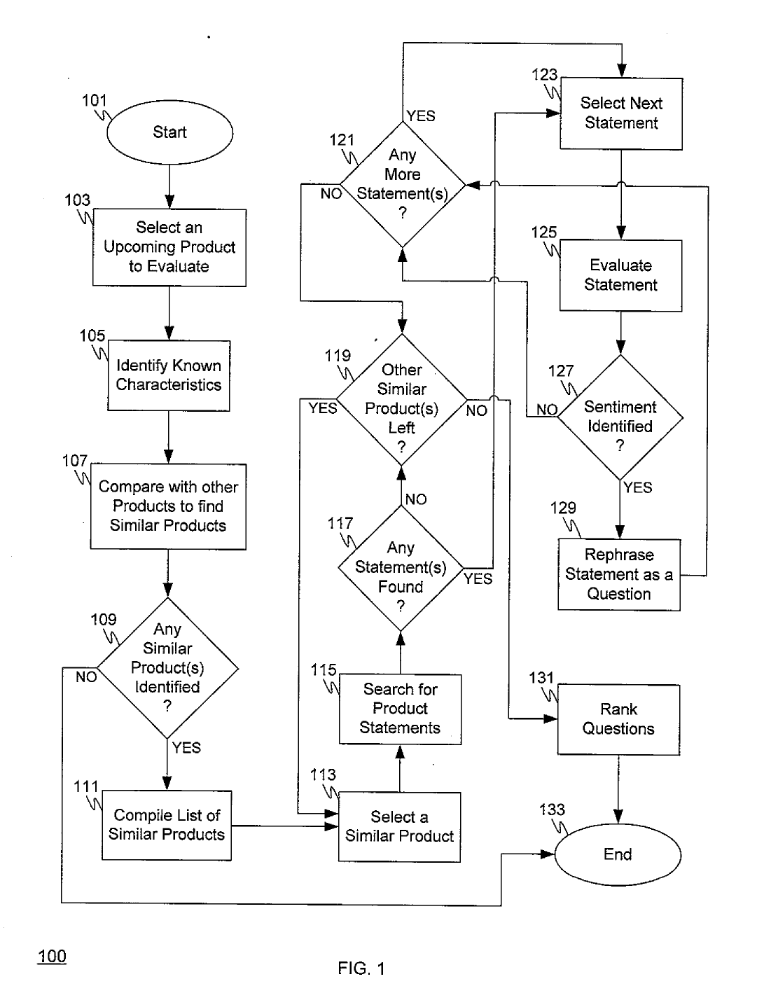

FIG. 1 is a flowchart depicting a method according to various embodiments disclosed herein for generating a question set for an upcoming product. The method begins in block 101 and proceeds to block 103 where an upcoming product is selected for analysis. The term “upcoming product” as used herein may mean a product being developed, a new product, a recently released product, or a revised/upgraded version of an existing product. The upcoming product may be hardware, software, steps of a method, or any combination of these three. Upon selecting a product in 103 the method proceeds to block 105 where characteristics of the product are identified.

A part identifying product characteristics may entail referring to existing written or recorded information such as schematics, drawings, photographs, specifications, product descriptions, instruction manuals, parts list, marketing information, or other text or oral descriptions of the product. Product characteristics may also be identified by one or more designers or engineers responsible for the product, or users familiar with the product, e.g., users conducting beta testing. In some instances the product characteristics may be identified by reviewing and altering the product characteristics of similar products such as the previous iteration of the product currently being developed. Once the characteristics have been identified in 105 the method proceeds to block 107.

Block 107 involves an analysis to identify similar products. The product similarity may be evaluated based on the product taxonomy and product features. In block 107 the characteristics of the current product are evaluated to determine whether other, similar products exist. In some instances this may result in identifying similar, yet unrelated, products—that is, products made by another. In other instances this may result in the inclusion of previous iterations of the current product. For example, if the product being evaluated is a new software version of a spreadsheet—say, Version 5.0—then the list of identified similar products will include Version 4.0 (and possibly Version 3.0, 2.0, etc.). The comparison of the products characteristics in block 107 may be based on the existence of a particular characteristic, or the extent (or amount) of a characteristic. For example, if the product is a flat screen television one characteristic of interest may be whether or not the TV has the dynamic contrast feature (existence), and further, what the dynamic contrast ratio is (extent).

Identifying similar products or services may be based on products taxonomy, and the use of a topology hierarchy to identify a set of similarity coefficients. The similarity coefficient may be calculated by traversing the topology tree and calculating the number of nodes to traverse. The more distant are two products—that is, the more dissimilar—the smaller is the similarity coefficient. A larger value similarity coefficient indicates a more similar product. One or more predefined parameters may be used to judge whether or not a product is similar to the selected upcoming product. For example, the predefined parameters may specify a minimum value for of the similarity coefficients a given number of product characteristics or product features. The similarity coefficients may be weighted based on their perceived importance to the product. Returning to the flat screen TV example, it may be the case that the dynamic contrast ratio is perceived to be much more important than the battery life of the remote control. In such a case the similarity coefficient for the dynamic contrast ratio would be weighed more heavily (say, 8 out of 10) than the similarity coefficient of the remote control's battery life (say, 2 out of 10). The similarity of a product may be based on a compilation of the weighted similarity coefficients of the product.

In some instances the one or more predefined parameters may be set to require the existence of certain characteristics, and the value of other characteristics. If a required characteristic is not present, the product would not be considered a similar product. A predefined parameter based on a characteristic value must fall within a predefined range or meet a predefined threshold—e.g., be within 20% of a predefined amount, or have a value of at least a predefined minimum amount. For example, the analysis of flat screen TVs could require that three characteristics exist: the TV has an LED screen, has the Dynamic Contrast feature, and displays HDTV. The flat screen TV analysis could also require that the screen be at least 52 inches in width (threshold) and have a dynamic contrast within 40% of 150,000:1 (range). Specifying more required predefined parameters, and specifying more precise predefined ranges, will each tend to result in fewer products being identified as similar products, but those that are identified will tend to be more like the product selected for analysis in block 103.

Once the other products have been compared in block 107—for example, using the predefined matching parameters used to identify a similar product—the method proceeds to block 109. In block 109 it is determined whether or not any similar products have been identified—that is, whether or not any of the products identified and analyzed meet the predefined parameters and similarity criteria set for the present analysis. If it is determined in block 109 that no similar products (or an insufficient number of similar products) have been identified the method proceeds from block 109 via the “NO” branch to block 131, and ends. In such an instance a user may go back and broaden the predefined parameters and similarity criteria to encompass more products as matches, and then conduct the comparison analysis of block 107 again. However, in block 109 if one or more similar products have been identified, then the method proceeds along the “YES” branch to block 111 to compile a list of similar products. Once the list of similar products has been put together in block 111 the method proceeds to block 113 to select a similar product to evaluate it for product statements.

In block 115 a search is conducted for product statements pertaining to the selected similar product. Product statements may be found from a number of sources. For example, when a person buys a new iPhone (or is considering the purchase of new iPhone) the person may ask others how this phone differs from previous versions of the iPhone. Such inquiries are often found on message boards, chat rooms, and other such venues where users ask questions and provide comments about given products. Such conversations may reveal popular features, or in some instances, shortcomings of the product. For example, one comment may involve the identification of the drawback that the old iPhone lacked a payment interface. For example, a company may release a new app product for the mobile phone market which is targeted towards students. An analysis of other mobile phone products is conducted, looking for students who have mobile phones with features similar to those of the new app product being released. The search for statements of sentiment may involve analyzing social media feedback from students with similar products. Key words are identified that are associated with available products.

The search for product statements typically involves processing information from a number of data sources referring to or discussing other, similar products. The data sources may include one or more of the following: social media sites such as Facebook or LinkedIn, Tweets or the like, consumer discussion sites or chatrooms, websites discussing or describing other products or the maintenance or trouble shooting other products, Internet discussion forums, or search engine results from searching the Internet. The data sources may also include internal sources or private sources such as the search results of previous searches, data from consumer brainstorming sessions, chat logs from customer service chatrooms, scanned images of product literature, transcripts of help-line telephone calls, or the like. Other data sources may include users' positive and negative feedback for existing products on message boards, blogs and chat rooms, advertising and marketing documents for the current products, and any other social networking metadata, rating, tagging, votes or “likes”. An indication of data relevance may be gleaned by determining how many times this information was viewed, or has been referenced in other documents. Another source of data may include the kind of feedback people get once the new product is announced—including, for example, people's feedback from the forums, blogs, or the like.

Various aspects of the disclosed embodiments may entail the use of natural language processing (NLP), machine learning (ML), or other such statistical text analysis techniques. For example, the searching of block 115, the identification of known characteristics of block 105, the search for similar products of block 107, and the evaluation of similar product statements of block 123 may each utilize NLP, ML or other such statistical text analysis techniques. The methods of searching for product statements of block 115 may use NLP, ML or other such statistical text analysis tools to parse and analyze buzz words and frequently used words in social media, finding correlation with most frequently asked questions about the product. These correlations to new products may be used to extract statements that may, in turn, be developed into new product questions. The statistical text analysis techniques may be used to extract questions from the social media, associating the media circle with product features and use that to identify the social media circles for new product. The type of questions asked by those groups may tend to be weighted more heavily since the questions would be more likely to be relevant. The statistical text analysis techniques may analyze the number and type of questions asked regarding similar products, may associate those products with historical sales events such as promotions, and apply learned correlations to the new product.

Upon completing the search in block 115 the method proceeds to block 117 to determine whether any statements have been found. If, in block 117, it is determined that no statements have been identified the method loops back around to search for statements associated with other similar products. The method proceeds from block 117 along the “NO” path to block 119 to determine whether there are any other similar products left to analyze. If there are other similar products left to consider the method proceeds along the “YES” path from block 119 to block 113 to select another similar product to analyze. If, in block 119, it is determined that all similar products have been consider, the method proceeds from block 119 along the “NO” path to block 131 to rank the questions in terms of relevance or perceived value to users.

Returning to block 117, if it is determined that one or more statements have been identified the method proceeds along the “YES” path to block 123 to select a statement for evaluation. Upon selecting a statement in 123 the method proceeds to block 125 to evaluate the statement. The evaluation of similar product statements performed in block 123 may utilize NLP, ML or another such statistical text analysis technique. Part of the evaluation involves determining whether sentiment is expressed towards the similar product. The sentiment may be an opinion, or user's feelings, towards a feature or characteristic of the similar product (e.g., “The resolution of this flat screen monitor gives it a sharper picture compared to Model X”), or an expression of how the product could be improved (“I wish the picture was clearer when the DVR is paused”). The method proceeds to block 127 to determine whether sentiment is detected for a particular statement.

If no sentiment is detected for a given statement the method proceeds from block 127 along the “NO” path back to block 121 to see whether there are other statements for to evaluate for that similar product. However, if block 127 indicates that an expression of sentiment has been identified the method proceeds along the “YES” path to block 129. In block 129 the identified statement of sentiment is analyzed and rephrased as an inquiry or question. It may be the case that a particular statement can be phrased in two or more of different manners as separate inquiries. For example, the statement “I like the sharp picture of this flat screen monitor compared to Model X,” could be rephrased as, “Does this flat screen monitor have as much resolution as compared to Model X?” Or alternatively, the statement “I like the sharp picture of this flat screen monitor compared to Model X,” could be rephrased as, “Is the picture quality as sharp for this flat screen monitor as compared to Model X?” If a given statement can be phrase as multiple questions, the questions may be stored as related questions. Alternatively, if the multiple questions are judged to be significantly different, they may be stored as separate questions.

Once all the similar products have been considered, and their statements identified and analyzed, the method proceeds from block 119 via the “NO” branch to block 131. In block 131 the questions are ranked based on predefined criteria. The criteria may include a weighting factor for the perceived importance of the feature or characteristic associated with the question based on statements discovered during the analysis. For example, the statement “The size of the flat screen monitor was the most important factor in my decision to buy Model X” would result in size being weighed heavily—that is, more important—as compare to other characteristics. Once the questions have been ranked and stored, the method proceeds to block 133 and ends.

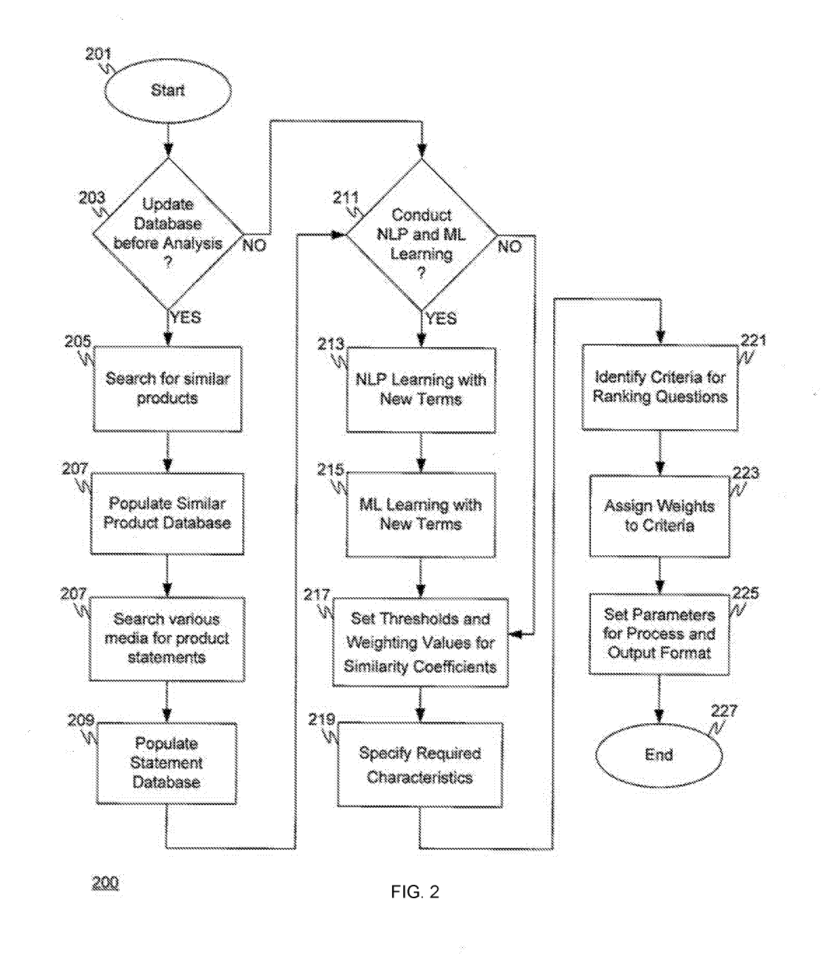

FIG. 2 is a flowchart depicting various preliminary and optional activities that may be performed in conjunction with the method of FIG. 1. The preliminary activities may involve updating the various searches ahead of time that to update the databases and internally stored information expected to be used in the analysis, running one or more training routines for the statistical text analysis tools to be used in the analysis, and specifying the parameters to be used in the searches, manipulation and presentation of data.

Turning to FIG. 2, the method begins in block 201 and proceeds to block 203 to determine whether or not the databases are to be updated prior to beginning the process depicted in FIG. 1. If no updating is to be performed the method proceeds along the “NO” branch from block 203 to block 211 to the training routines portion of the preliminary activities. If, however, it is determined in block 203 that the databases are to be updated the method proceeds from block 203 via the “YES” branch to block 205 to search for similar products. The search for similar products may be performed in a manner similar to that described in block 107 of FIG. 1. Upon completing the search for similar products the method proceeds to 207 to store the results in a database of similar products. The term “database” has been used herein for the format in which search results are stored. However, in practice the various search results could be stored in any number of formats, including in the simplest form for example, simply a list of names or terms. The method proceeds to block 207 to search various media sources for product statements associated with each similar product. The search for product statements may be performed in a manner similar to that described in block 115 of FIG. 1. Upon completing the search for product statements the method proceeds to block 209 to store the search results.

The method proceeds from block 209 to block 211 to determine whether to conduct NLP and/or ML learning routine. Statistical text analysis tools such as NLP and ML may be enhanced by running them through a training routine prior to the analysis. The training routine allows them acquire text and phrasing likely to be encountered in a particular technology or for a given new product. The training routine may involve a search for buzzwords and product-specific jargon. Performing the training routine aids in producing better results by providing a context of terminology and definitions for the statistical text analysis tools prior to conducting the searches and analysis. In block 211 if it is determined that no training routines are to be run the method proceeds from block 211 along the “NO” path to block 217. However, if it is determined in block 211 that training routines are to be performed for the statistical text analysis tools then the method proceeds from 211 to 213.

In block 213 the NLP training routine may involve the introduction of new terms, jargon, buzzwords and definitions that pertain to the new product to be introduced and the technology in general. The training routine may also involve new terms, jargon, buzzwords and definitions for expressions of sentiment. Since the data sources include text from human users, the language will tend to be fluid. New terms—including slang and terms/phrases from popular media (e.g., movies, songs)—will make their way into the vernacular. The training seeks to capture these terms so as to accommodate changes in human language. In addition the training make seek to understand specialized contextual means. For example, the use of the word “bad” does not necessarily imply a negative review. A high school student Tweeting, “The new version of VideoGameX is totally bad!,” likely means that the Tweet author gives it a positive review. Upon completing NLP learning routine in 213 the method proceeds to 215 to conduct an ML learning routine. The learning process for ML may be performed in a similar manner as described for NLP learning to incorporate new terms, jargon, buzzwords and definitions that pertain to the new product being introduced and the technology in general, as well as for expressions of sentiment.

Upon completing the NLP and ML training routines the method proceeds to block 217 set the thresholds for the similarity coefficients. Similarity coefficients provide an indication of the similarity, or dissimilarity, of two products being compared. The similarity coefficient for a pair of products tends to be larger if they are more similar, and smaller of they are less similar. In block 217 the user may set the value that a similarity coefficient must be in order for a product to be considered a similar product to the new product being introduced. That is, the predefined parameters may specify the minimum value for of the similarity coefficients a given number of product characteristics or product features. The similarity coefficients may be weighted based on their perceived importance to the product. The user may set the weighting coefficients in block 217 to approximate the perceived importance of the various product characteristics or features. Once the weighting coefficients have been set in block 217 the method proceeds to block 219.

In block 219 the user is able to specify one or more characteristics or features that will be required in order for the product to be considered similar for the purpose of the analysis. If a required characteristic or feature is not present, the product will not be considered a similar product. Similarly, the user may set a range (or threshold) for a measurable characteristic or feature. If the measurable characteristic or feature of a product falls outside that range (or below/above the threshold) the product will not be considered a similar product. Once the required features and characteristics are selected, and any applicable ranges or thresholds are set, the method proceeds from block 219 to block 221.

In block 221 the criteria for ranking the questions are decided upon. A question concerning an issue associated with a buy/no buy decision may, in some instances, be weighted heavily for relevance. For products in a market that is very price sensitive, questions concerning price or cost may be weighted heavily. For some products there may be one or more parameters that are of most significant to consumers. For example, if a person is purchasing a mattress for their bed, then the comfort of the mattress may be among the most significant parameters. In other instances the questions concerning issues that have the greatest impact on manufacturing or development costs may be weighted more heavily. Once the criteria for ranking the questions has been determined in block 221, and the weights assigned to those criteria in block 223, the method proceeds to block 225 and ends.

In block 225 the user may specify parameters controlling the output of the analysis. For example, it is sometimes the case that similar questions will be generated. For example, the system may generate the following two questions: “Is the new app backward compatible with data generated by the previous version of the app?” and “Does the new app have the same features and controls as the previous version of the app?” The user may choose to group all the questions dealing with previous versions of the app together, regardless of their ranking criteria relative to other questions. In other instances the system may return two separate questions that deal with the same issue, or are simply stated in a slightly different manner. For example, the system may generate the following two questions: “How long does it take the GPS unit to lock onto a signal when the unit is moving?” and “What is the refresh rate for new GPS locations when the unit is moving?” In such instances the user may specify in block 225 that the two similar questions are both to be presented, or alternatively, the system will prompt the user with a choice to select one or both questions for including in the final product.

Another aspect of the output involves a limit on the number of questions to be included in the final output. For example, in some instances the system may generate a great number of questions, including many questions of marginal or no interest to the user. The system may allow a parameter to be set to limit the number of questions in the final output to a given number, e.g., 50 questions, 100 questions, 250 questions, 500 questions, 1,000 questions or the like. The system may also be set to return all questions that exceed a predefined value for relevance, for example, defined by the ranking coefficient. Alternatively, the system may be set to return all generated questions. Once the parameters controlling the output of the analysis have been specified in block 225, the method proceeds to block 227 and ends.

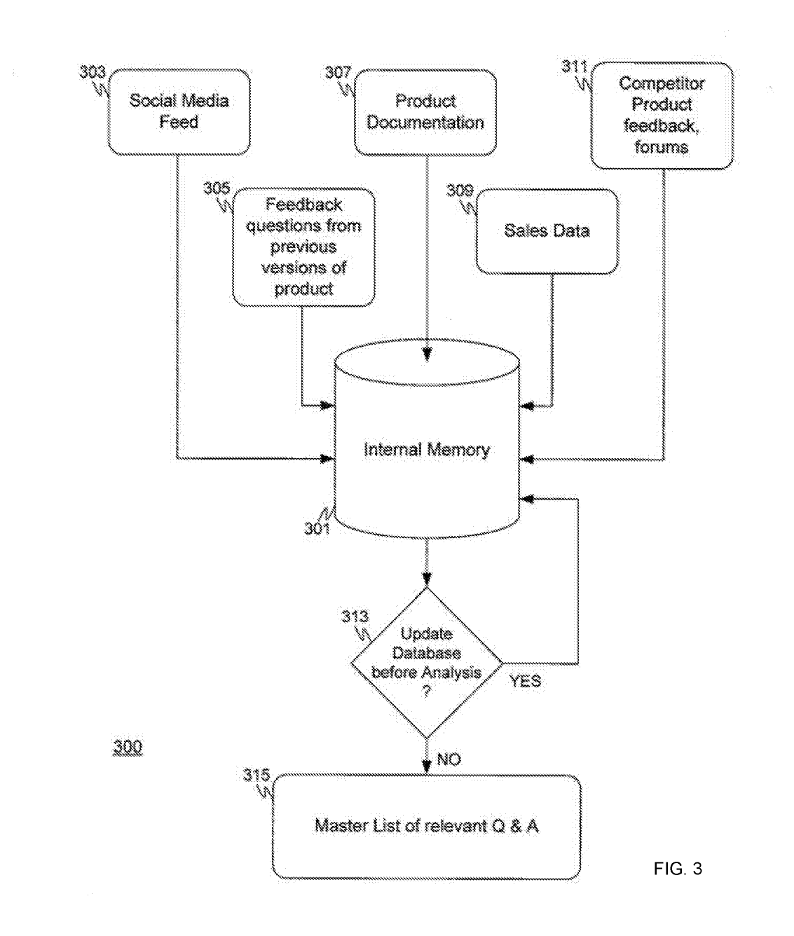

FIG. 3 depicts a block diagram of various elements in accordance with embodiments disclosed herein. Blocks 303 to 311 depict various sources of data and information to be used in the analysis. Block 303 depicts social media feed. This may include discussions and reviews found on message boards, chat rooms, blogs, and other such venues where users ask questions and provide comments about given products, as well as tweets, Facebook, LinkedIn, or other like social media outlets. Block 305 includes feedback questions from previous versions of the product. This may include the results of the previous, similar analysis done at the time the previous versions was developed. It may also include scripts tailored for the telephone help line personnel and technical support personnel. Block 305 may also include questions and comments generated from transcripts of user telephone calls and correspondence inquiries.

Block 307 includes product documentation, typically from engineering and marketing of the product. The documentation includes various specifications, user's manual(s), and descriptions of the various features and part of the product. The sales data of block 309 may include various sales volume, if any, ads and marketing literature, and also information from the sales force as it pertains to various features, advantages, drawbacks and user opinions of the product. Block 311 includes feedback and opinions on competitor's similar products from various sources.

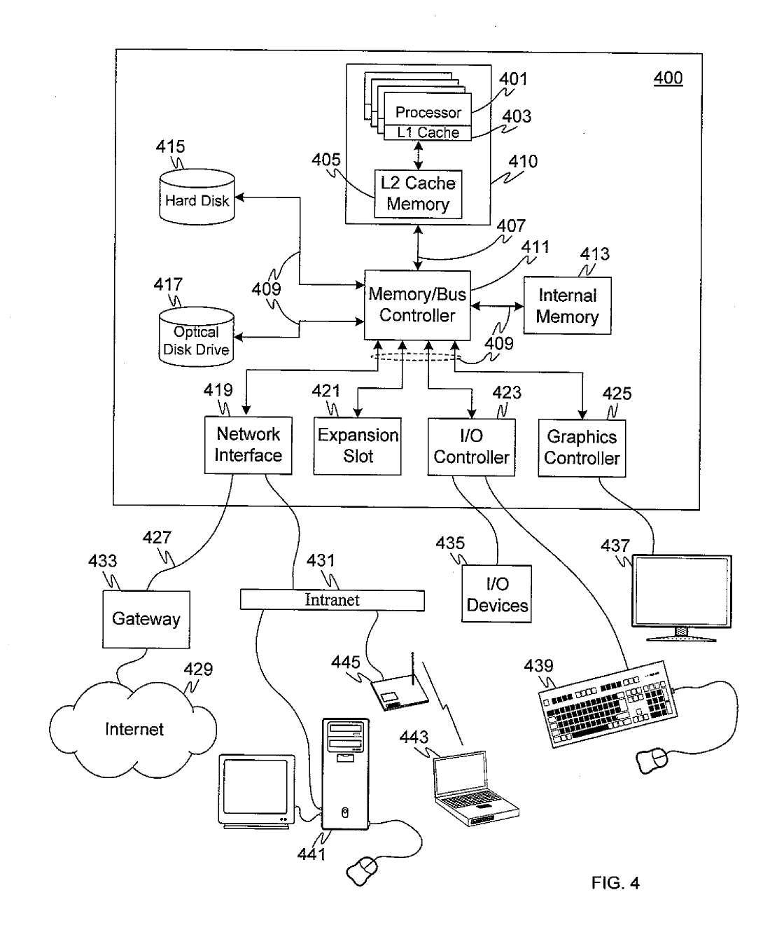

FIG. 4 depicts computer and hardware systems for use in implementing various embodiments disclosed herein. Although FIG. 4 depicts a computer system 400 and components suitable for implementing the various embodiments, one of ordinary skill in the art would know that various other computer configurations and computing devices could also be adapted to implement the various embodiments. The computer system 400 may be configured in the form of a desktop computer, a laptop computer, a mainframe computer, or any other hardware or logic arrangement capable of being programmed or configured to carry out instructions. In some embodiments the computer system 400 may act as a server, accepting inputs from a remote user over a local area network (LAN) 427, the Internet 429, or an intranet 431. In other embodiments, the computer system 400 may function as a smart user interface device for a server on the LAN 427 or over the Internet 429. The computer system 400 may be located and interconnected in one location, or may be distributed in various locations and interconnected via communication links such as a LAN 427 or a wide area network (WAN), via the Internet 429, via the public switched telephone network (PSTN), a switching network, a cellular telephone network, a wireless link, or other such communication links. Other devices may also be suitable for implementing or practicing the embodiments, or a portion of the embodiments. Such devices include personal digital assistants (PDA), wireless handsets (e.g., a cellular telephone or pager), and other such electronic devices preferably capable of being programmed to carry out instructions or routines. Although only one typical architecture is depicted in FIG. 4, those of ordinary skill in the art may recognize that many different computer architectures may be suitable for the computer system 400.

Computer system 400 may include a processor 401 which may be embodied as a microprocessor, two or more parallel processors as shown in FIG. 4, a central processing unit (CPU) or other such control logic or circuitry. The processor 401 may be configured to access a local cache memory 403, and send requests for data that are not found in the local cache memory 403 across a cache bus to a second level cache memory 405. Some embodiments may integrate the processor 401, and the local cache 403 onto a single integrated circuit and other embodiments may utilize a single level cache memory or no cache memory at all. Other embodiments may integrate multiple processors 401 onto a single die and/or into a single package. Yet other embodiments may integrate multiple processors 401 with multiple local cache memories 403 with a second level cache memory 405 into a single package 410 with a front side bus 407 to communicate to a memory/bus controller 411. The memory/bus controller 411 may accept accesses from the processor(s) 401 and direct them to either the internal memory 413 or to the various input/output (I/O) busses 409. Some embodiments of the computer system 400 may include multiple processor packages 410 sharing the front-side bus 407 to the memory/bus controller. Other embodiments may have multiple processor packages 410 with independent front-side bus connections to the memory/bus controller. The memory bus controller may communicate with the internal memory 413 using a memory bus 409.

The internal memory 413 may include one or more of random access memory (RAM) devices such as synchronous dynamic random access memories (SDRAM), double data rate (DDR) memories, or other volatile random access memories. The internal memory 413 may also include non-volatile memories such as electrically erasable/programmable read-only memory (EEPROM), NAND flash memory, NOR flash memory, programmable read-only memory (PROM), read-only memory (ROM), battery backed-up RAM, or other non-volatile memories. In some embodiments, the computer system 400 may also include 3^{rd} level cache memory or a combination of these or other like types of circuitry configured to store information in a retrievable format. In some implementations the internal memory 413 may be configured as part of the processor 401, or alternatively, may be configured separate from it but within the same package 410. The processor 401 may be able to access internal memory 413 via a different bus or control lines than is used to access the other components of computer system 400.

The computer system 400 may also include, or have access to, one or more hard drives 415, optical disk drives 417, or other types of storage memory used for computers and electronic devices. Hard drives 415 and the optical disks for optical disk drives 417 are examples of machine readable (also called computer readable) mediums suitable for storing the final or interim results of the various embodiments. The optical disk drives 417 may include a combination of several disc drives of various formats that can read and/or write to removable storage media (e.g., CD-R, CD-RW, DVD, DVD-R, DVD-W, DVD-RW, HD-DVD, Blu-Ray, and the like). Other forms or computer readable media that may be included in some embodiments of computer system 400 include, but are not limited to, floppy disk drives, 9-track tape drives, tape cartridge drives, solid-state drives, cassette tape recorders, paper tape readers, bubble memory devices, magnetic strip readers, punch card readers or any other type or computer useable or machine readable storage medium.

The computer system 400 may either include the hard drives 415 and optical disk drives 417 as an integral part of the computer system 400 (e.g., within the same cabinet or enclosure and/or using the same power supply), as connected peripherals, or may access the hard drives 415 and optical disk drives 415 over a network, or a combination of these. The hard drive 415 often includes a rotating magnetic medium configured for the storage and retrieval of data, computer programs or other information. In some embodiments, the hard drive 415 may be a solid state drive using semiconductor memories. In other embodiments, some other type of computer useable medium may be used. The hard drive 415 need not necessarily be contained within the computer system 400. For example, in some embodiments the hard drive 415 may be server storage space within a network that is accessible to the computer system 400 for the storage and retrieval of data, computer programs or other information. In some instances the computer system 400 may use storage space at a server storage farm, or like type of storage facility, that is accessible by the Internet 429 or other communications lines. The hard drive 415 is often used to store the software, instructions and programs executed by the computer system 400, including for example, all or parts of the computer application program for carrying out activities of the various embodiments.

The communication link 409 may be used to access the contents of the hard drives 415 and optical disk drives 417. The communication links 409 may be point-to-point links such as Serial Advanced Technology Attachment (SATA) or a bus type connection such as Parallel Advanced Technology Attachment (PATA) or Small Computer System Interface (SCSI), a daisy chained topology such as IEEE-1394, a link supporting various topologies such as Fibre Channel, or any other computer communication protocol, standard or proprietary, that may be used for communication to computer readable medium. The memory/bus controller may also provide other I/O communication links 409. In some embodiments, the links 409 may be a shared bus architecture such as peripheral component interface (PCI), microchannel, industry standard architecture (ISA) bus, extended industry standard architecture (EISA) bus, VERSAmoduleEurocard (VME) bus, or any other shared computer bus. In other embodiments, the links 409 may be a point-to-point link such as PCI-Express, HyperTransport, or any other point-to-point I/O link. Various I/O devices may be configured as a part of the computer system 400.

In many embodiments, a network interface 419 may be included to allow the computer system 400 to connect to a network 427 or 431. Either of the networks 427 and 431 may operate in accordance with standards for an IEEE 802.3 ethernet network, an IEEE 802.11 Wi-Fi wireless network, or any other type of computer network including, but not limited to, LANs, WAN, personal area networks (PAN), wired networks, radio frequency networks, powerline networks, and optical networks. A network gateway 433 or router, which may be a separate component from the computer system 400 or may be included as an integral part of the computer system 400, may be connected to the networks 427 and/or 431 to allow the computer system 400 to communicate with the Internet 429 over an internet connection such as an asymmetric digital subscriber line (ADSL), data over cable service interface specification (DOCSIS) link, T1 or other internet connection mechanism. In other embodiments, the computer system 400 may have a direct connection to the Internet 429. The computer system 400 may be connected to one or more other computers such as desktop computer 441 or laptop computer 443 via the Internet 429, an intranet 431, and/or a wireless node 445. In some embodiments, an expansion slot 421 may be included to allow a user to add additional functionality to the computer system 400.

The computer system 400 may include an I/O controller 423 providing access to external communication interfaces such as universal serial bus (USB) connections, serial ports such as RS-232, parallel ports, audio in and audio out connections, the high performance serial bus IEEE-1394 and/or other communication links. These connections may also have separate circuitry in some embodiments, or may be connected through a bridge to another computer communication link provided by the I/O controller 423. A graphics controller 425 may also be provided to allow applications running on the processor 401 to display information to a user. The graphics controller 425 may output video through a video port that may utilize a standard or proprietary format such as an analog video graphic array (VGA) connection, a digital video interface (DVI), a digital high definition multimedia interface (HDMI) connection, or any other video connection. The video connection may connect to display 437 to present the video information to the user.

The display 437 may be any of several types of displays or computer monitors, including a liquid crystal display (LCD), an organic light emitting diode (OLED) array, or other type of display suitable for displaying information for the user. Typically, the computer system 400 includes one or more user input/output (I/O) devices such as a keyboard and mouse 439, and/or other means of controlling the cursor represented including but not limited to a touchscreen, touchpad, joystick, trackball, tablet, or other device. The user I/O devices 435 may connect to the computer system 400 using USB interfaces or other connections such as RS-232, PS/2 connector or other interfaces. Various embodiments include input devices configured to accept an input from a user and/or provide an output to a user. For example, some embodiments may include a webcam (e.g., connect via USB), a microphone (e.g., connected to an audio input connection), and/or speakers (e.g., connected to an audio output connection). The computer system 400 typically has a keyboard and mouse 439, a monitor 437, and may be configured to include speakers, microphone, and a webcam. These input/output devices may be used in various combinations, or separately, as means for presenting information to the user and/or receiving information and other inputs from a user to be used in carrying out various programs and calculations. Speech recognition software may be used in conjunction with the microphone to receive and interpret user speech commands.

The processor 401 may be embodied as a microprocessor, microcontroller, DSP, RISC processor, two or more parallel processors, or any other type of processing unit that one of ordinary skill would recognize as being capable of performing or controlling the functions, steps, activities and methods described herein. A processing unit in accordance with at least one of the various embodiments can operate computer software programs stored (embodied) on computer-readable medium such those compatible with the disk drives 415, the optical disk drive 417 or any other type of hard disk drive, floppy disk, flash memory, ram, or other computer readable medium as recognized by those of ordinary skill in the art.

As will be appreciated by those of ordinary skill in the art, aspects of the various embodiments may be embodied as a system, method or computer program product. Accordingly, aspects of the various embodiments may take the form of an entirely hardware embodiment, an entirely software embodiment (including firmware, resident software, micro-code, or the like) or an embodiment combining software and hardware aspects that may all generally be referred to herein as a “circuit,” “module,” “logic” or “system.” Furthermore, aspects of the various embodiments may take the form of a computer program product embodied in one or more computer readable medium(s) having computer readable program code stored thereon.

Any combination of one or more computer readable medium(s) may be utilized. The computer readable medium is typically a non-transitory computer readable storage medium. Such a non-transitory computer readable storage medium may be embodied as, for example, an electronic, magnetic, optical, electromagnetic, infrared, or semiconductor system, apparatus, or device, or other like storage devices known to those of ordinary skill in the art, or any suitable combination of the foregoing. Examples of such computer readable storage medium include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Computer program code for carrying out operations and aspects of the various embodiments may be written in any combination of one or more programming languages, including an object oriented programming language such as Java, Smalltalk, C++, or the like, and conventional procedural programming languages, such as the “C” programming language or similar programming languages. In accordance with various implementations, the program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the various embodiments are described with reference to flowchart illustrations and/or block diagrams of methods, apparatus, systems, and computer program products according to various embodiments disclosed herein. It will be understood that blocks of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks, including for example, the computer and hardware system depicted in FIG. 4.

The computer program instructions may also be stored in a computer readable medium that can direct a computer, a programmable data processing apparatus, or other such devices to function in a particular manner, such that the instructions stored in the computer readable medium produce an article of manufacture including instructions which implement the function/act specified in the flowchart and/or block diagram block or blocks. The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and/or block diagrams in the figures help to illustrate the architecture, functionality, and operation of possible implementations of systems, methods and computer program products according to the various embodiments. In this regard, each block in the flowchart or block diagrams may represent a module, segment, or portion of code, which comprises one or more executable instructions for implementing the specified logical function(s). It should also be noted that, in some alternative implementations the functions noted in the block may occur in an order other than that depicted in the figures. For example, two blocks shown in succession may, in fact, be executed substantially concurrently, or the blocks and activities of the figures may sometimes be executed in reverse order or in a different order, depending upon the functionality involved. For example, the search for product statements in block 115 of FIG. 1 may take place after each similar product is identified in blocks 107-109, rather than performing block 115 after all similar products have been identified. In another example, the NLP and ML learning of FIG. 2 bocls 213 and 215 may take place concurrently with the rest of the activities depicted in FIG. 1 rather than occurring before the method of FIG. 1 begins. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises,” “comprising,” “includes,” and/or “including” used in this specification specify the presence of stated features, integers, steps, operations, elements, and/or components, but do not preclude the presence or addition of one or more other features, integers, steps, operations, elements, components, and/or groups thereof. The term “obtaining”, as used herein and in the claims, may mean either retrieving from a computer readable storage medium, receiving from another computer program, receiving from a user, calculating based on other input, or any other means of obtaining a datum or set of data. The term “plurality”, as used herein and in the claims, means two or more of a named element. It should not, however, be interpreted to necessarily refer to every instance of the named element in the entire device. Particularly, if there is a reference to “each” element of a “plurality” of elements. There may be additional elements in the entire device that are not be included in the “plurality” and are not, therefore, referred to by “each.”

The corresponding structures, materials, acts, and equivalents of all means or step plus function elements in the claims below are intended to include any structure, material, or act for performing the function in combination with other claimed elements as specifically claimed. The description of the various embodiments has been presented for purposes of illustration and description, but is not intended to be exhaustive or limited to the form disclosed. Many modifications and variations will be apparent to those of ordinary skill in the art without departing from the scope and gist of the various embodiments. The various embodiments included herein were chosen and described in order to best explain the principles of operation and the practical application, and to enable others of ordinary skill in the art to understand the embodiments with various modifications as are suited to the particular use contemplated.

What is claimed is:

1. A method of generating a set of questions about an upcoming product, the method comprising:
select an upcoming product characterized by a plurality of product characteristics;
identify a plurality of similar products, each of the similar products having one or more of the plurality of product characteristics;
search for and find product statements associated with each of the plurality of similar products;
rephrase the product statements to be inquiries about the upcoming product; and
create the set of questions from the product statements rephrased to as the inquiries about the upcoming product.

2. The method of claim 1, further comprising:
perform an evaluation to identify sentiment in said product statements.

3. The method of claim 1, wherein the evaluation to identify the sentiment in said product statements includes the use of natural language processing (NLP) or machine learning (ML) to parse and analyze text of said product statements.

4. The method of claim 1, wherein the identifying of the plurality of similar products further comprises:
search and find potential products based on each of the similar products having one or more of the plurality of product characteristics.

5. The method of claim 4, further comprising:
evaluate the potential products to determine a degree of similarity to the upcoming product; and
select a subset of the potential products to be the plurality of similar products.

6. The method of claim 5, wherein the degree of similarity is based on similarity coefficients identified using a topology hierarchy.

7. The method of claim 5, wherein each of the plurality of similar products are those among the potential products determined to have a highest degree of similarity to the upcoming product.

8. The method of claim 1, wherein the search for said product statements comprises an Internet search of message boards, blogs and at least one social media site.

9. The method of claim 1, further comprising:
ranking said inquiries based on one or more predetermined criteria for determining relevance to users.

10. A computer program product for generating a set of questions about an upcoming product, the computer program product comprising a non-transitory computer readable storage medium having computer instructions embodied therewith that, upon being executed on a computer, cause the computer to perform steps comprising:
selecting an upcoming product characterized by a plurality of product characteristics;
identifying a plurality of similar products, each of the similar products having one or more of the plurality of product characteristics;
searching for and finding product statements associated with each of the plurality of similar products;
rephrasing the product statements to be inquiries about the upcoming product; and
creating the set of questions from the product statements rephrased to as the inquiries about the upcoming product.

11. The computer program product of claim 10, further comprising:
performing an evaluation to identify sentiment in said product statements;
wherein the evaluation to identify the sentiment in said product statements includes the use of natural language processing (NLP) or machine learning (ML) to parse and analyze text of said product statements.

12. The computer program product of claim 10, wherein the identifying of the plurality of similar products further comprises:
searching and finding potential products based on each of the similar products having one or more of the plurality of product characteristics.
evaluating the potential products to determine a degree of similarity to the upcoming product; and
selecting a subset of the potential products to be the plurality of similar products.

13. The computer program product of claim 12, wherein the degree of similarity is based on similarity coefficients identified using a topology hierarchy.

14. The computer program product of claim 12, wherein each of the plurality of similar products are those among the potential products determined to have a highest degree of similarity to the upcoming product; and
wherein the search for said product statements comprises an Internet search of message boards, blogs and at least one social media site.

15. The computer program product of claim 10, further comprising:
ranking said inquiries based on one or more predetermined criteria for determining relevance to users.

16. A computer configured to execute instructions for generating a set of questions about an upcoming product, the computer comprising:
a processor configured to execute the instructions to select an upcoming product characterized by a plurality of product characteristics, said processor being further configured to execute the instructions to identify a plurality of similar products, each of the similar products having one or more of the plurality of product characteristics;
a network connection through which a search may be conducted for product statements associated with each of the plurality of similar products; and
a memory configured to store rephrased versions of the product statements, said rephrased versions comprising inquiries about the upcoming product;
wherein the processor is further configured to execute the instructions to create the set of questions from the product statements rephrased to as the inquiries about the upcoming product.

17. The computer of claim 16, wherein the processor is further configured to execute the instructions to perform an evaluation to identify sentiment in said product statements;
wherein the evaluation to identify the sentiment in said product statements includes the use of natural language processing (NLP) or machine learning (ML) to parse and analyze text of said product statements.

18. The computer of claim 16, wherein the identifying of the plurality of similar products further comprises search and find potential products based on each of the similar products having one or more of the plurality of product characteristics;
wherein the processor is further configured to evaluate the potential products to determine a degree of similarity to the upcoming product, and select a subset of the potential products to be the plurality of similar products.
